(19) United States
(12) Patent Application Publication
(10) Pub. No.: US 2009/0126766 A1
(43) Pub. Date: May 21, 2009

(54) DISH WASHER AND STEAM PROVIDING UNIT FOR THE SAME

(75) Inventors: Byung-Hwan Ahn, Kyungsangnam-do (KR); Soung-Bong Choi, Kyungsangnam-do (KR); Deug-Hee Lee, Kyungsangnam-do (KR); Seong-Hae Jeong, Kyungsangnam-do (KR); Hung-Myoung Cho, Kyungsangnam-do (KR); Hyeok-Deok Kim, Kyungsangnam-do (KR)

Correspondence Address: MCKENNA LONG & ALDRIDGE LLP, 1900 K STREET, NW, WASHINGTON, DC, 20006, US

(73) Assignee: LG Electronics, Inc., Seoul (KR)

(21) Appl. No.: 11/795,873

(22) PCT Filed: May 24, 2006
(86) PCT No.: PCT/KR2006/001947

§ 371 Date: Aug. 13, 2008

(30) Foreign Application Priority Data
May 31, 2005 (KR) 10-2005-0046094
May 31, 2005 (KR) 10-2005-0046097
May 31, 2005 (KR) 10-2005-0046099
May 31, 2005 (KR) 10-2005-0046102
May 31, 2005 (KR) 10-2005-0046104
May 31, 2005 (KR) 10-2005-0046107
May 31, 2005 (KR) 10-2005-0046111

(51) Int. Cl. B08B 3/10

(52) U.S. Cl. 134/56 D; 134/106

(57) ABSTRACT

A dish washer according to the present invention comprises: a tub putting dishes into; a steam generator providing the steam into the inside of the tub; a steam supplying channel connecting the steam generator and the tub; and a steam discharging part provided on an end portion of the steam supplying channel to spread the steam to the inside of the tub.

### TECHNICAL FIELD

The present invention relates to a dish washer, and particularly, to a dish washer having a system providing steam into the inside of the dish washer and having a steam providing unit for the same. More particularly, the present invention relates to a dish washer, and steam providing unit for the same that the function becomes various, and washing efficiency is improved as the high temperature steam is provided to the inside of the dish washer.

### BACKGROUND ART

In general, a dish washer is a home electronic appliances that a washing water is discharged with a high pressure, from the inside of the tub, and a foreign elements like food remnants on the surface of the dishes are washed as the discharged water is touched on the dishes. The food remnants are leached out by a filter so as to recycle the washing water, and a detergent is mixed in the water so as to separate the food remnants from the dishes smoothly.

In order to improve the original function of the dish washer above-mentioned, the methods are being more proposed to improve the efficiency as the following.

First, the way that can make detergent be mixed well by heating the washing water to improve the washing efficiency has proposed, and tried to remove the hard remnants like rice paste smoothly by high temperature washing water.

Further, dividing the dish washing process into preliminary washing and main washing, and making the food remnants to be steeped on the beginning washing section have been tried to accomplish the process reliably. Also, a device that the proliferation of the bacteria is inhibited by emitting the UV rays on the washed dishes has been proposed.

However, there still were problems to improve the efficiency of the dish washing even according to the related art, especially in Asian cultural area which rice is used as the staple food, the washing efficiency become an issue by a reason of the dried rice remnants on the dishes does not get removed easily. This kind of problem does not get solved completely even if the steeping course is accomplished by the high temperature washing water. Furthermore, because of a long taking steeping course, a dish washing process which takes longer becomes a problem.

There is a problem that the efficiency of the dish washer becomes low, because of the said problem.

### DISCLOSURE OF INVENTION

### Technical Problem

The present invention is proposed to solve the above-mentioned problems. A purpose of the present invention is to propose the dish washer having the steam providing system which improves the dish washing efficiency by making the food remnants that remain on the dish washer get removed easily.

A purpose of the present invention is providing the steam providing system that improves a user's convenience, as a steeping course is accomplished rapidly, the dish washing process can be getting shorter.

Present invention is also proposing a dish washer and a steam providing system which provides steam rapidly into the inside of a tub.

### Technical Solution

To achieve the purpose of the dish washer according to the present invention, the dish washer comprises: a tub putting the dishes into; a steam generator providing the steam to the inside of the tub; a steam supplying channel connecting the steam generator and the tub; and a steam discharging part provided on an end portion of the steam supplying channel to spread the steam, to the inside of the tub.

In another aspect, the dish washer according to this invention comprises: a tub putting the dishes into; a steam generator provided on the lower part of the tub and producing steam; a steam supplying channel connecting the steam generator and the tub; and a steam discharging part provided on an end portion of the steam supplying channel, and installed on the bottom of the tub to spread the steam to the inside of the tub.

In another aspect, the dish washer according to this invention comprises: a tub; a sump installed on a lower surface of the tub, and storing the washing water, a steam generator provided on a lower side of the tub, and generating steam; a steam supplying channel connecting the steam generator and the tub; and a steam discharging part provided on the end of the steam supplying channel, and installed towards the bottom of the tub.

In another aspect of the dish washer according to the present invention comprises: a tub; a door installed ratatably at the tub; a washing water injecting nozzle installed on an inside portion of the tub; a steam generator installed on an outer surface of the tub; and a steam discharging part installed on about the middle of the tub and discharging the steam generated by the steam generator to the inside of the tub.

In another aspect of the dish washer according to the present invention comprises: a dish washer comprising: a tub; a steam generator mounting a heater to heat the provided washing water and installed on the outside of the tub; a steam supplying channel discharging the steam generated by a steam generator into the inside of the tub; a steam discharging part installed on the end of the steam supplying channel, spreading the steam with an atomized condition, or injecting the steam with a pre-determined pressure.

### ADVANTAGEOUS EFFECTS

By the present invention, the washing of the dishes can be accomplished physically, chemically and biologically at the same time, therefore, it is advantageous that the use efficiency can be improved.

Also, as a steeping course is accomplished rapidly, it is advantageous that a dish washing process gets shorter, the removement of the foods remnants remained on the dishes is perfectly accomplished. It can obtain the advantage that the sterilization effect is increased, because the high temperature steam can be spread in several processes.

Further, it is advantageous that the steam using efficiency gets increased because the steam that injects into the inside of the tub can be spread into an entire space of the inside of the tub.

### BRIEF DESCRIPTION OF THE DRAWINGS

FIG. 1 is a perspective view of a dish washer according to the present invention;

FIG. 2 is a perspective view of a dish washer according to the present invention, which shows a state that a door is opened;

FIG. 3 is a cross-sectional view, which is cut along I-I′ line;

FIG. 4 is a cross-sectional view of the dish washer mounting the steam providing unit according to the embodiment 2 of the present invention;

FIG. 5 is a magnified cross-sectional view of FIG. 4.

FIG. 6 is a cross-sectional view that shows a dish washer mounting the steam providing unit according to the embodiment 3 of the present invention;

FIG. 7 is a cross-sectional view, which shows a dish washer mounting the steam providing unit according to the embodiment 4 of the present invention;

FIG. 8 is a cross-sectional view, which shows a dish washer mounting the steam providing unit according to the preferred embodiment 5 of the present invention;

FIG. 9 is a incised perspective view, which shows a dish washer mounting the steam providing unit according to the embodiment 6 of the present invention;

FIG. 10 is a cross-sectional view of the dish washer according to the embodiment 6 of the present invention.

FIG. 11 is a cross-sectional view of a steam generator according to the concept of the present invention;

FIG. 12 is another embodiment of a steam generator according to the concept of the present invention;

FIG. 13 is a flow chart explaining the controlling method of the dish washer according to the present invention.

### BEST MODE FOR CARRYING OUT THE INVENTION

Reference will now be made in detail to the preferred embodiments that are concrete of the present invention, examples of which are illustrated in the accompanying drawings. Merely, the concept is not confined to the preferred embodiment that is supported to the appended drawings, who understands. The manufacturers who understand the concept of the present invention able to suggest could be another embodiment comprehended in an identical extent according to the additions of the constitution elements, alterations, deletions, and additions.

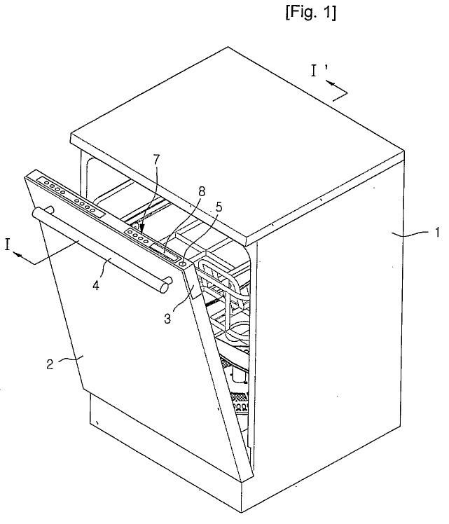

FIG. 1 is a perspective view of the dish washer according to the present invention.

Referring FIG. 1, a dish washer comprises a case 1 capable of opening the front, and forming the external appearance, a door 2 opening and closing the opened front of the case 1, a control panel 3 provided on an upper side of the door 2, and indicating and controlling the operation of the dish washer.

Particularly, the control panel 3 comprises a power switch 5 making the power on/off of the dish washer, a door handle 4 used to open and close the door 2, a function control unit 7 that enables a predetermined action to perform by a user's selection, and a display unit 8 displaying the operating condition of the dish washer.

### The Preferred Embodiment 1

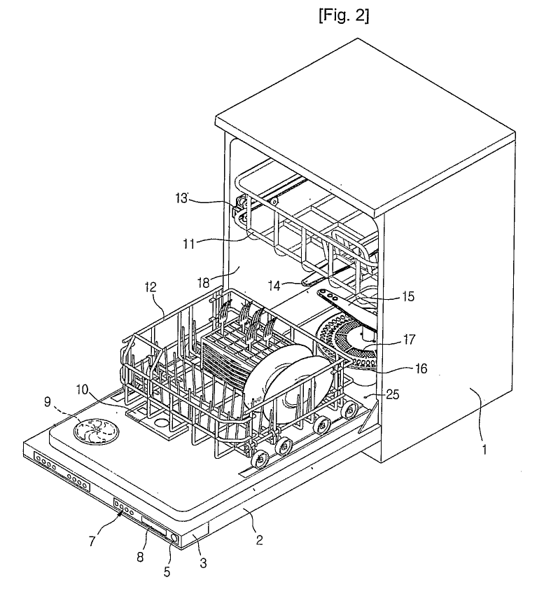

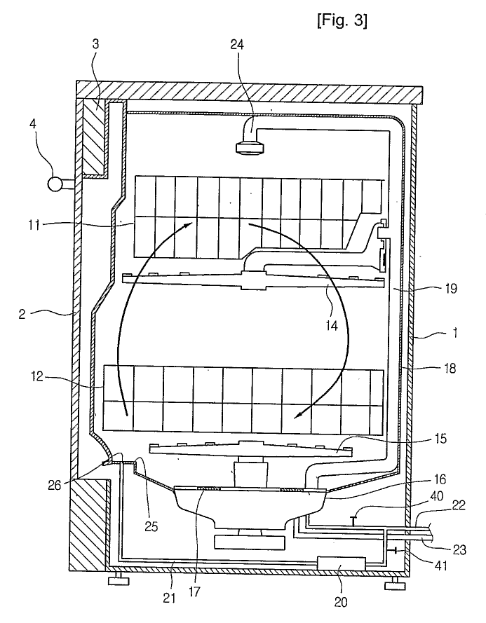

FIG. 2 is a perspective view showing the state of the opened door of a dish washer according to the present invention, and FIG. 3 is a cross-sectional view of FIG. 1 cut along I-I′.

Referring to FIG. 2 and FIG. 3, in the inside of the dish washer, a tub 18 storing the washing water is disposed, and underneath the tub 18, a sump 16 that catches the washing water, strains the foreign elements and injects the water again is combined.

Particularly, In the inside of the tub 18, a plurality of dish racks 11, 12 which can be divided into high and low, nozzles 14, 15, 24 which inject the washing water towards each of the dish racks 11, 12 are supplied. Rails 13 supporting the movement of the dish rack are extended towards the back and front directions on the side surface of the tub 18. Further, a filter 17 is combined with the upper surface of the sump 16, the foreign elements passing the filter 17 are strained.

In addition, on a inside surface of the tub 18, a water guide 19 which provide the washing water through the upper nozzle 14 is provided.

The door 2 is combined with the case 1 by hinge on the low part and is able to rotate the back and forth directions in accordance with the user's operation. The ventilating fan 9 is formed on the predetermined location at the door 2 to exhaust the air in the tub 18 compulsorily out by the ventilating fan during the drying process.

On one side surface of the door 2, a detergent inlet 10 supplying the detergent is formed to be supplied a constant amount of the detergent into the inside of the detergent inlet when the dish washer operates.

A dish washer according to the invention comprises: a water supplying channel 22 supplying the water to the inside of the tub 18, and connecting the outside of the dish washer and the tub; a water draining channel 23 draining the polluted water after used for washing; a steam generator 20 located on the lower side of the tub 18, and generating steam; a steam supplying channel 21 providing as a connecting channel supplying the steam generated by the steam generator to the inside of the tub 18.

The water channel 22 is branched to supply the washing water simultaneously or selectively to the sump 16 and the steam generator 20. A valve for the tub 40, and a valve for the steam 41 are formed respectively to control the amount of the water supplied to the sump 16 and stem generator 20 along the branched water supplying channel, particularly, the valve for the tub 40 controls the amount of the water supplied to the tub, and the valve for the steam 41 controls the amount of the water supplied to the steam generator 20.

Particularly, a steam discharging part 26 is formed on the end of the steam supplying channel 21 to discharge the steam to the inside of the tub.

More particularly, the steam discharging part 26 is provided to a protuberance part 25 which is protuberant with a predetermined extent.

The movement of the dish washer according to the present invention as suggested is briefly explained as following. When intending to wash the dishes, first, open the door 2, put the dishes on the dish rack 11, 12, put the dish rack on the right place, and close the door 2. To be sure, It is possible to put certain amount of the detergent or rinse, etc, into a detergent inlet 10 before closing the door 2. Then, as operating the function operating part 7, pushing the operating button after input a user's desired washing condition and course, the washing process is accomplished as well as the movement condition of the dish washer is displayed on the display unit 8.

On the other hand, as explaining the movement of the dish washer in regard to the current of the washing water circulated the inside of the tub 18, the washing water injected from the nozzle 14, 15, 24 fall behind and circulates to the sump 16 after washing the dishes putting on the dish racks 11, 12.

A washing pump mounting an impeller is located in the inside of the sump 16, providing the washing water again through the nozzles 14, 15, 24 with adding pressure. Thus, as the food remnants to be strained by a filter during the washing water is circulated the nozzles 14, 15, 24 from the sump 16, prevent the excessive contamination of a washing water or the clogging of the nozzles.

particularly, in case that a steam discharging part is provided on the lower part, because the weight of the high temperature steam is light, the steam moves up smoothly, finally spread widely and rapidly to the inside of the tub 18. Also, it is not apprehended that the washing water stream into the steam discharging part 26, because the steam discharging part is provided on a protuberance part 25 which is protruded with a predetermined height on a lower part. Thus, preferably, the protuberance part 25 is protruded higher than the surface of the water in the inside of the tub 18.

Thus, on a certain condition on the process of the movement of the dish washer, the condition that the steam generated from the steam generator 20 is provided to the tub through the steam supplying channel 21, further proceeds. Therefore, It is possible to expect the improved efficiency and the reliability on the movement of the dish washer additionally obtained by high temperature and humid feature of the steam.

### The Preferred Embodiment 2

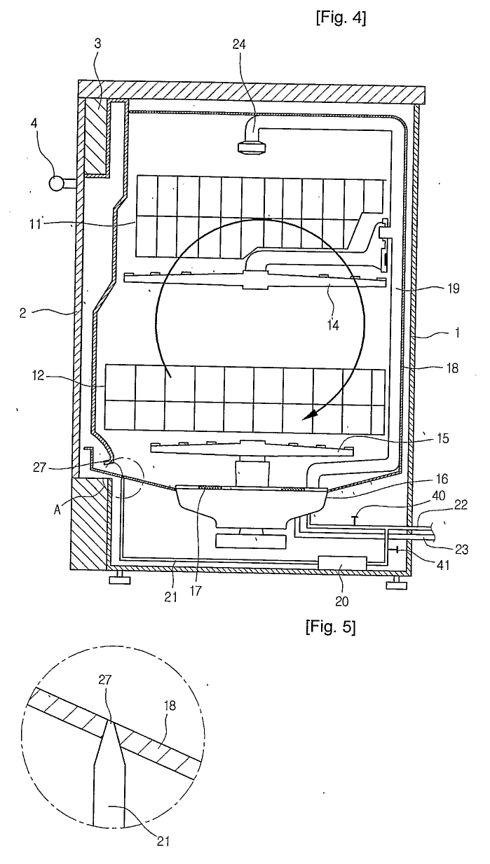

FIG. 4 is a cross-sectional view of the dish washer mounting a steam providing unit according to the preferred embodiment 2 of the present invention.

Referring to FIG. 4, the inner structure of a dish washer is identified with the thing explained on the embodiment 1, but there is a little difference on the constitution of a steam providing unit.

particularly, the injecting nozzle 27 is connected with the end of the steam supplying channel 21 to inject the steam from the inside of the tub 18 even to the far edge. Thus, as injecting the steam to all around even to the edge of a tub 18 through an injecting nozzle 27, it is possible to spread the steam rapidly to the inner part of the tub 18.

FIG. 5 is a magnified cross-sectional view of part A of FIG. 4

Referring to FIG. 5, on a condition that a part of the tub 18 is protruded towards the inside, the diameter of the steam supplying channel 21 is tapered off, the end of the steam supplying channel 21 forms the injecting nozzles 27.

Thus, because the diameter of the end of the steam supplying channel 21 is tapered off, the steam circulated through the steam supplying channel 21 is circulated to a long distanced space of the tub 18 through the injecting nozzle, like the arrow given on FIG. 4. Taking a look at the arrow, the steam injecting from the injecting nozzle 27 is spread first towards the upper space of the tub 18 by the injecting pressure. After that, the steam is cooled and then goes down to the lower part through the opposite side. Thus, because the circulating direction is decided in the inside of the tub 18, the steam is supplied to the inside of the tub 18 rapidly and entirely.

### The Preferred Embodiment 3

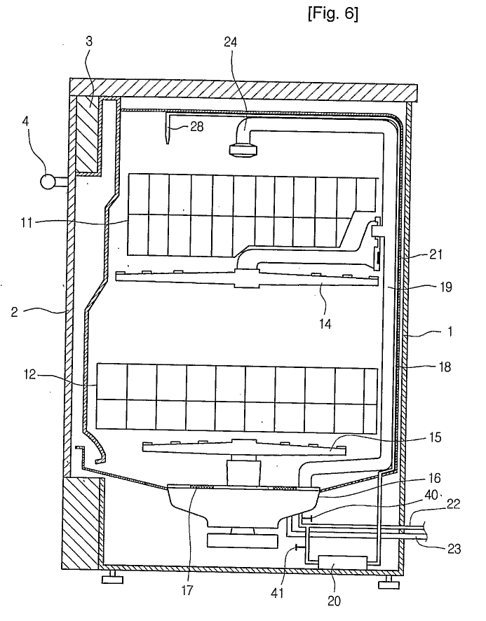

FIG. 6 is a cross-sectional view of a dish washer mounting a steam providing unit according to the embodiment 3 of the present invention.

Referring to FIG. 6, the inner structure of a dish washer is identified with the thing explained on the embodiment 1, but there is a little difference on the structure of the constitution of the steam providing unit.

Particularly, the steam discharging part 28 is formed to discharge the steam on the end of the steam supplying channel 21, the steam discharging part is formed on the upper surface of the tub 18 to prevent inflowing of the washing water towards the steam supplying channel even if the washing water injects to the inside of the tub 18. additionally, the steam supplying channel 21 draws alongside of the water guide 19, extended to upward and downward on the inside of the rear part of the tub 18.

On the other hand the diameter of the steam discharging part is identified with the diameter of the steam supplying channel 21 as indicated on the embodiment 1, so the stream provided can be separated to the inside of a tub with atomized condition, Otherwise, make the steam discharged with a predetermined pressure as making the diameter tapered off as indicated on the embodiment 2

particularly, in case that the steam discharging part 28 is provided on the upper surface of the tub 18, because there is not any apprehension that the washing water can be flow into the inner part of the channel through the steam discharging part 28, even if the washing water injects out, so the reliability of the movement of the dish washer is improved. therefore, it is prevented the situation that the food remnants becomes rotten as the washing water influxes into the steam discharging part 26 with the food remnants.

Also, because the steam supplying channel 21 is extended to upward and downward through the inner surface of the rear part of the tub 18, there is no obstruction for the tub 18 to be sealed.

### The Preferred Embodiment 4

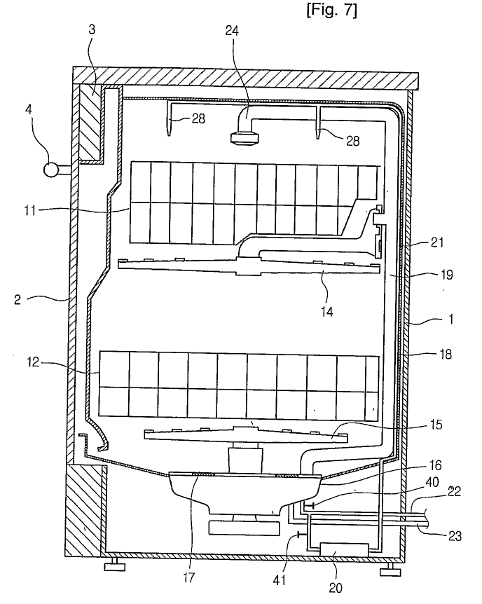

FIG. 7 is a cross-sectional view of the dish washer possessed the steam providing unit according to the embodiment 4 of the present invention. Referring to FIG. 7, the inner structure of the dish washer is identified with the thing explained on the embodiment 1, but there is a little difference on the structure of the constitution of the steam providing unit.

Particularly, the steam supplying channel 21 is guided to the upper part of the tub 18, and at least two steam discharging part 28 discharging the steam from the upper part to the lower direction of the inside of the tub 18 are provided.

Thus, as the plurality of the steam discharging part 28 are provided, the steam can be supplied to all around of the inner space of the tub 18 rapidly and entirely. Furthermore, in case that the steam discharging part 28 is formed as a nozzles, because the steam discharged downwardly from the nozzle can be circulated rapidly to the low part of the tub 18 by the injecting pressure.

In case that the plurally of steam discharging parts 28 are provided because the steam is distributed all around in the inner part of the tub in a short time, even if the steam is spreaded with an atomized condition, it is fine, even if the end of the steam discharging part is not formed as a nozzle.

### The Preferred Embodiment 5

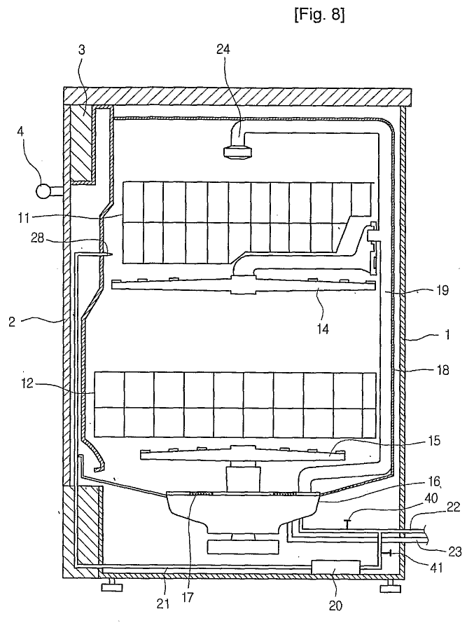

FIG. 8 is a cross-sectional view of a dish washer mounting the steam providing unit according to the embodiment 5 of the present invention.

Referring to FIG. 8 the dish washer is identified with the thing explained on the embodiment 1, but there is a little difference on the structure of the constitution of the steam providing unit.

Particularly, the steam discharging part 28 formed on the end of the steam supplying channel 21, and discharging the steam, is formed on the inside of the door 2 to prevent inflowing of the washing water pooled the bottom of the tub 18 towards the steam supplying channel, even if the washing water injects into the tub 18. And it is needed to prevent being occurred the problem on the steam supplying as a result of the damage of the steam supplying channel 21.

To prevent this kind of problem, preferably, at least a part of the steam supplying channel 21 which is on the lower part of the door 2 is made up of as a flexible pipe material.

By the flexible structure of pipe, there is on obstruction for supplying the steam through the steam supplying channel 21, even if the door is opened.

Further, as the steam discharging part 28 is formed on the inside of the door 2, comparatively a lot of steam rapidly influences on the front part more than behind part of the tub 18. Hence, in case that the dishes which needs to be washed are a small quantity, the washing efficiency by steam can be improved and gathering the dishes out can be easier at the same time as putting the dishes on the front part of the dish racks 11, 12. According to the various condition like that, there are profitable advantages on improving the effect of steeping the dishes by the steam and of sterilizing the dishes, in case of providing the steam discharging part 28 in the door side.

Of course, the steam is spread from the steam discharging part 28 with atomized condition, or the end of the steam discharging part 28 is formed as a nozzle to inject the steam with a predetermined pressure are the same as the above explained.

### The Preferred Embodiment 6

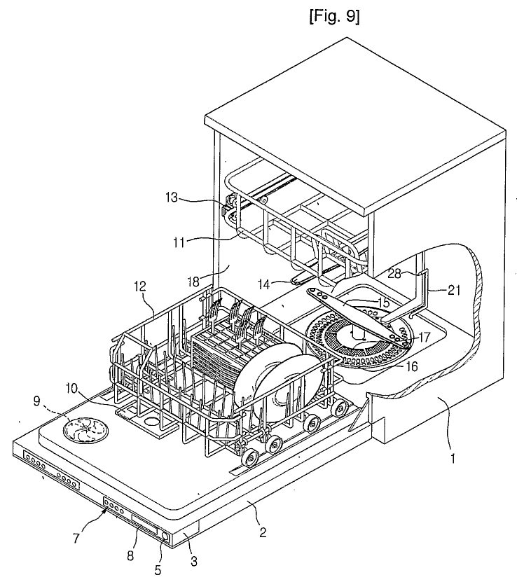

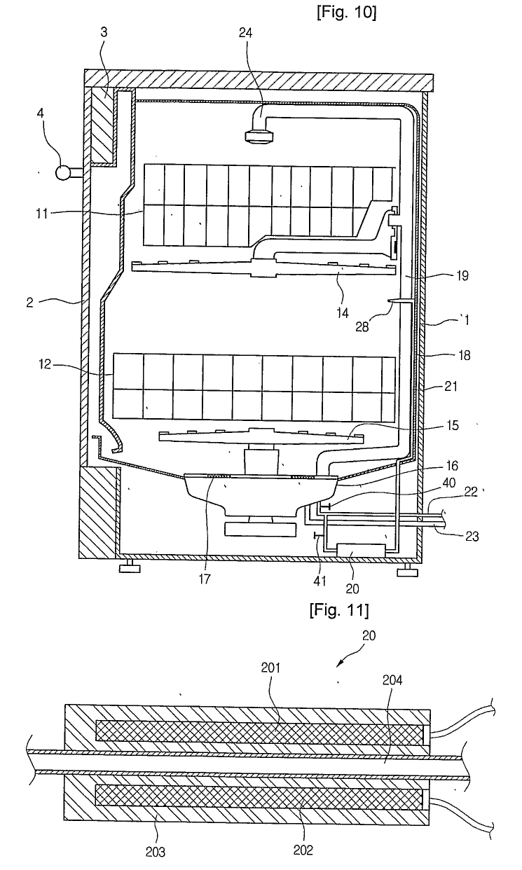

FIG. 9 is an operated perspective view of the dish washer possessed a steam providing unit according to the preferred embodiment 6 of the present invention; FIG. 10 is a cross-sectional view of the dish washer according to the embodiment 6.

Referring to FIG. 9 to 10, the inner structure of the dish washer is identified with the thing explained on the preferred embodiment 1, but there is a little difference on the structure of the constitution of the steam providing unit.

Particularly, the steam discharging part discharging the steam on the end of the steam supplying channel 21 is formed on the surface of the rear part of the tub 18, and make the washing water pooled on the bottom part of the tub 18 not to influx into the steam supplying channel 21, even if the washing water is inject out into the inside of the tub 18. The steam supplying channel 21, along side of water guide 19, extended to up and downwards on the inside of the rear surface of the tub 18.

More particularly, the steam discharging part 28 is provided on about the middle height of the tub 18, so the steam can be spread equally towards any directions of the upper part and lower part. that is, if the steam discharging part 28 is located on the space between the upper dish rack 11 and the lower dish rack 12, it is advantageous that the steam is supplied equally to the dishes which is put either side of the dish racks 11, 12.

Besides, it is possible that at least two of the steam discharging port discharging the steam is formed on the steam discharging part 28, and the each steam discharging port is formed towards each of the dish racks. Particularly, forming one of the steam discharging ports towards the upper part dish rack 11, and forming the other steam discharging port towards the lower part dish rack, so the steam is distributed equally. Because the steam discharging port is formed as a nozzle, it is also possible to be discharged with a predetermined pressure.

FIG. 11 is a cross-sectional view of the steam generator according to the concept of the present invention.

Referring to FIG. 11, the steam generator 20 provided to the dish washer of the present invention is working with the pipe heating method, the heating unit is attached on the outer circumference of the pipe that the washing water streams, the washing water is heated and circulated at the same time, and injected directly to the inside of a tub. Therefore, it is possible that the steam can be supplied rapidly on the time when a user desires the steam to be generated.

Particularly, the steam generator 20 comprises: a evaporating pipe 204 connected with the pipe channel flowed through the water supply channel 22, a heater 201, 202 adjoined the circumference of the evaporating pipe 204 and supplying the heat into the inside of the evaporating pipe 204, a heat conduction part 203 transferring the heat rapidly between the heater 201, 202 and the evaporating pipe 204.

Particularly, a cease heater which is heated by the approval the power from outside can be used, the amount of the water supplied to the evaporating pipe 204, is controlled by the valve 41 of the steam side.

Also, excepting a plurality of the cease heaters mounted on the outer circumference of the evaporating pipe 204, the heaters 201, 202 can be surrounded of the entire outer circumference of the evaporating pipe 204. That is, if the entire outer circumference of the evaporating pipe 204 is surrounded by the heater, as the heating transfer efficiency gets increased, there is an effect that the time taking for evaporating the washing water gets reduced. It is advantageous that, if the situation which needs the steam according to the composition as occurs, if the water is supplied as opening the valve 41 and approving the power on a heater 201, 202, the steam is generated almost at the same time as the water is applied, and being supplied into the inner part of a tub.

Furthermore, the quantity of the heat transferred to the tub can be controlled by the power of the heaters 201, 202, and the supply amount of the steam is capable of direct controlling according to the opening amount of the channel, and the opening time of the channel. Therefore, it is advantageous that the steam controlling of the dish washer can be accomplished more directly.

By the steam generator of the pipe heating method, it is possible to direct control in case of large amount of calorification is required, made the steam generator to be long, and amount of approved power to be large. Further, in case of a large amount of the steam is needed, the steam supplying amount is easily controlled to adjust the opening amount of the valve of the steam 41.

According to the steam generator 20 which has the pipe heating method as above-mentioned, there are merits that it is possible to supply the steam when the system wants, and the direct control of the amount of appliance and the total amount of the calorification is possible.

The steam provided from the dish washer according to the present invention can be controlled according to the accommodating amount of the dishes and the kinds of the goods, and can be governed according to a user's selections. For instance, it is easily guessed that, if the amount of the dishes is large, a large amount of the steam is provided.

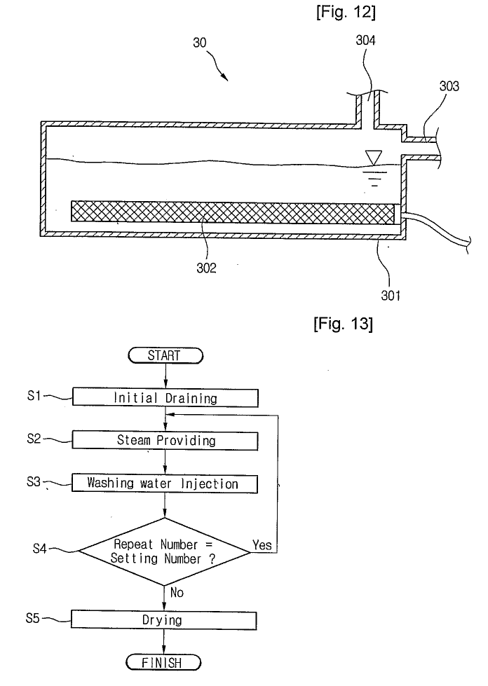

FIG. 12 is another preferred embodiment of the steam generator according to the concept of the present invention.

Referring to the FIG. 12, the steam generator 30 according to the present invention comprises: a case 301 storing the water supplied through the water supplying pipe channel 22; a heater 302 fixed on about the lower part of the case 301, and capped into the water; a water supplying port 303 provided on a side of the case and supplied the water passing through the water supplying channel 22 to the case; and a water discharging port 304 provided on about the upper part of the case 301 to discharge the steam heated by the heater 302.

Particularly, the heater 302 can be cease heater. Even not illustrated, it is possible to install a buoyant on the inside of the case 301, so as the amount of water filled with the inner part of the case 301 to be controlled, or as the opening condition and time of the valve which is on the steam part to be regulated.

As explaining the movement of the steam generator 30 of tub heating method, first, make the inside of the case 301 filled with a constant amount of water, make the steam to be generated as heating water when the steam is needed after the water is filled. The steam generated by the heat from the heater 302 flows into the steam supplying channel 21 through the water discharging port 304 provided on the upper surface of the case, and can be flew to the inside of the tub.

As installed the steam generator 30 of the tub heating method, the purity of the steam generated on the steam generator 30 is raised. That is, the water and steam do not be injected to the steam discharging port together, but only pure steam can be discharged through the steam discharging port 304, so it is not apprehended that the water can be inlet into the inside of the tub, Like this, because, the steam of the state of high purity is provided to the inside of the tub, there is merit that the steeping effect of the food remnants and the sterilization effect are increase.

The steam provided on the dish washer according to the present invention can be different according to the accommodating amount of the dishes and kinds of the goods, and can be controlled according to a user's selection. For instance, it is easily guessed if the amount of the dishes is large, a large amount of the steam is provided.

FIG. 13 is a flow chart explaining the control method of the dish washer according to the present invention.

Referring to FIG. 13, after putting the dishes on the inside of the dish washer, the movement of the dish washer starts, then the initial draining process S1 is progressed that the water put in the inside of the dish washer is discharged. And after accomplished the initial draining process, the steam is provided into the inside of the tub 18 S2. The steam providing process S2 is accomplished according to the process that the steam generated on the steam generator is provided into the inside of the tub 18 through the steam supplying channel 21.

The time taking for providing and the amount can be different according to the amount of the dishes and the cleaned condition of the dishes. For instance; in case if the rice remnants are dried on the dishes and does not be off well, providing the steam longer should be desirable.

After the food remnants being steeped as accomplished the steam providing step for a time, the washing water is injected towards the dishes S3. At this time, even if the washing water is injected with a low pressure, there is no difficulty on washing the food remnants, because the food remnants are steeped by the steam.

After finishing the first around that step S2 and a washing water injecting steps S3, the washing water injecting step S3 and steam providing step are accomplished again according to the dish washing course which is programmed or a user's selection. Thus, the process is accomplished if the repeating frequency is not reached to the established frequency is not reached to the established frequency as comparing the repeating frequency and the established frequency of a washing water injecting step and steam providing step.

Like this, if the washing water injecting frequency takes longer and longer, because, the time takes longer for the food remnants to be steeped, the amount of the food remnants remained on the dishes is reduced. Furthermore because the food remnants, remained on the dishes are being soaked during the steam providing process S2, the food remnants can be removed from the dishes more perfectly.

As above explained, as being accomplished the washing water injecting process and the steam providing process by alternation and repeatedly, because the food remnants can be removed more reliably from the dishes, the merit can be obtained that the washing efficiency is improved.

*Desirably, at the alternate accomplishing process of the washing water injecting process S3 and the steam providing process S3 and the steam providing process S2, as providing the detergent at least once to accomplishment, make even the oil stain removed perfectly from the dishes.

preferably, prevent detergent remaining on the dishes as accomplishing the washing process without the washing material during the washing water injecting process S3 and steam providing process S2.

After finished the injecting of the washing water as being accordance with repeating frequency and the established frequency, a drying process S5 is progressed longer provided cold wind and hot wind.

The steam provided at the control method of the dish washer according to the present invention can be different and the kinds of the goods, and can be governed according to d user's selection.

For instance, it is easily guessed, when the amount of the dishes is large, a large amount of steam is provided.

As the thing explained, the control method of a dish washer, because the steam providing and washing water injecting are accomplished repeatedly as alternated, the merit can be obtained that the washing efficiency is more improved.

Like this improvement of the washing efficiency is achieved as coming the food remnants off the dishes easily by steeping with the provided steam and further, as the sterilization of the bacteria on the dishes by the high temperature steam.

That is, it is advantageous that the cleanness of the dishes to be higher in physically by being soaked of the food remnants according to the steam providing.

Furthermore, the alternated accomplishing process is accomplished several times, there is advantage that the washing efficiency is increased as mush as accomplished alternately.

On the other hand as another preferred embodiment of the present invention, the steam providing process S2 and the washing water injecting process S3 can be accomplished at the same time.

That is, it is possible that the washing water can be injected as well as accomplishing the steam providing motion.

Thus, a advantage that the time taking to the entire process is reduced in case that the steam providing and washing water injecting are accomplished at the same time.

### INDUSTRIAL APPLICABILITY

The possibilities of utilization in industrial is very high, because there is on effect that the dishes are always washed in a clean condition as are eradicated and the foreign elements stick on the dishes are removed easily and sterilized by the high temperature steam according to a dish washer mounted the steam providing unit making the high temperature steam to be provided to the inside of the tub.

1. A dish washer comprising:
a tub putting the dishes into;
a steam generator providing the steam to the inside of the tub;
a steam supplying channel connecting the steam generator and the tub; and
a steam discharging part installed on an end portion of the steam supplying channel to spread the steam to the inside of the tub.

2. The dish washer according to claim 1, wherein the steam discharging part is located at least one side of the inner circumference of the tub.

3. The dish washer according to claim 1, wherein the dish washer further comprises a door installed rotatably at the tub, and the steam discharging part located at the inside of the door.

4. The dish washer according to claim 1, wherein the steam discharging part is installed towards the center of the tub.

5. The dish washer according to claim 1, wherein the steam discharging part is a nozzle injecting the steam with a predetermined pressure.

6. The dish washer according to claim 1, wherein the steam is spread from the steam discharging part with atomized condition to the inside of the tub.

7. The dish washer according to claim 1, wherein the steam discharging part is provided at least two from one steam generator.

8. The dish washer according to claim 1, wherein the heating method of the steam generator is a tub-heating method.

9. The dish washer according to claim 1, wherein the heating method of the steam generator is a pipe-heating method.

10. A dish washer comprising:
a tub putting the dishes into;
a steam generator provided on the lower part of the tub and producing steam;
a steam supplying channel connecting the steam generator and the tub; and
a steam discharging part provided on an end portion of the steam supplying channel, and installed on the bottom of the tub to spread the steam to the inside of the tub.

11. The dish washer according to claim 10, wherein the bottom in which the steam discharging part is installed is protruded with a predetermined height towards the upper side compared with the other parts.

12. The dish washer according to claim 11, wherein the protruded part is higher than the height of the washing water pooled on the bottom of the tub.

13. The dish washer according to claim 10, wherein the steam discharging part is installed towards the upper side, the steam discharged to the inside of the tub is circulated in the inside of the tub.

14. The dish washer according to claim 10, wherein the diameter of the steam discharging part is identical with the steam supplying channel or is getting narrower as going to the end.

15. A dish washer comprising:
a tub;
a sump installed on a lower surface of the tub, and storing the washing water;
a steam generator provided on a lower side of the tub, and generating steam;
a steam supplying channel connecting the steam generator and the tub; and
a steam discharging part provided on the end of the steam supplying channel, and installed towards the bottom of the tub.

16. The dish washer according to claim 15, wherein the steam discharging part is installed plurally at the ceiling part of the tub.

17. The dish washer according to claim 15, wherein the steam supplying channel is arranged along the inner circumference of the tub.

18. The dish washer according to claim 15, wherein the dish washer further comprises a water supplying pipe supplying the washing water to the sump, and the steam supplying channel is branched on the water supplying pipe.

19. The dish washer according to claim 15, wherein the steam discharging part is a nozzle of which diameter is getting narrower.

20. A dish washer comprising:
a tub;
a door installed ratatably at the tub;
a washing water injecting nozzle installed on an inside portion of the tub;
a steam generator installed on an outer surface of the tub; and
a steam discharging part installed on about the middle of the tub and discharging the steam generated by the steam generator to the inside of the tub.

21. The dish washer according to claim 20, wherein the steam discharging part is installed on an inner circumference part of the door.

22. The dish washer according to claim 20, wherein the steam discharging part is located on a rear surface part of the tub.

23. The dish washer according to claim 20, wherein the dish washer further comprises a steam supplying channel connecting the steam discharging part and the steam generator, and the steam supplying channel is extended with a pre-determined length along the inner circumference of the tub or inside of the door.

24. The dish washer according to claim 23, wherein the steam supplying channel extended along the inside of the door is partially made up of a flexible pipe.

25. The dish washer according to claim 20, wherein the steam discharging part is consisted of a form divided into two pieces, so the steam is injected towards the upper dish rack and lower dish rack respectively.

26. The dish washer according to claim 20, wherein the washing water injecting nozzle and the steam discharging part operate simultaneously or alternately.

27. a dish washer comprising:
a tub;
a steam generator mounting a heater to heat the provided washing water and installed on the outside of the tub;
a steam supplying channel discharging the steam generated by a steam generator into the inside of the tub;
a steam discharging part installed on the end of the steam supplying channel, spreading the steam with an atomized condition, or injecting the steam with a predetermined pressure.

28. The dish washer according to claim 27, wherein the steam generator further comprise an evaporating pipe having the heater installed adjacent to the outer circumference thereof, and
a heat conduction plate mounted between the evaporating pipe and the heater to transfer the heat generated from the heater to the evaporating pipe.

29. The dish washer according to claim 28, wherein a washing water provided to the evaporating pipe is heated by the heater, and the evaporating pipe is a part of the steam supplying channel.

30. The dish washer according to claim 28, further comprising a valve controlling the amount of the washing water providing to the evaporating pipe.

31. The dish washer according to claim 27, wherein the steam generator comprise a case for storing the washing water;
a water supplying port connected to a predetermined portion of the case; and,
a discharging port connected to the upper side of the case; and
the heater is accommodated in the inside of the case.

32. The dish washer according to claim 31, further comprising a valve controlling the amount of the washing water provided to the water supplying port.

33. The dish washer according to claim 31, wherein a level of the washing water is maintained in a lower state than the height of the discharging port to discharge only the pure steam through the discharging port.

34. The dish washer according to claim 31, wherein the discharging port is connected with the steam supplying channel.
